(19) United States
(12) Patent Application Publication
(10) Pub. No.: US 2025/0211000 A1
(43) Pub. Date: Jun. 26, 2025

(54) FIRE SAFE ELECTRIC VEHICLE (EV) CHARGING SYSTEM

(71) Applicant: Siemens Industry, Inc., Alpharetta, GA (US)

(72) Inventors: Daniel Feldman, New York, NY (US); Mark Kadoshnikov, Marietta, GA (US)

(73) Assignee: Siemens Industry, Inc., Alpharetta, GA (US)

(21) Appl. No.: 18/394,107

(22) Filed: Dec. 22, 2023

(51) Int. Cl. H02J 7/00; B60L 53/14; B60L 53/66; B60L 53/67; B60Q 1/52; B60Q 5/00; G08B 17/10

(52) U.S. Cl. CPC H02J 7/0029; B60L 53/66; B60L 53/67; B60Q 1/52; G08B 17/10; H02J 7/0042; B60L 53/14; B60Q 5/005

(57) ABSTRACT

An electric vehicle (EV) charging management system comprises an EV charging system for charging a Li-Ion battery and an automatic mechanism related to charging of a hybrid/electric vehicle (H/EV) to avoid or restrict fires affecting the Li-Ion battery. The automatic mechanism comprises a heat/smoke/gas/particle sensor, a turn-off switch, a processor and a memory storing software (SW) instructions that, when executed by the processor, cause the automatic mechanism to detect a fire and shut off charging to H/EV(s). The automatic mechanism further comprises a fire alarm system for protecting a certain zone. The fire alarm system includes different control groups, with a set of causes and effects. The EV charging management system to connect an EV charger to a control group. The EV charging management system can shut down all EV chargers either in a same zone as where the fire is detected, or in an entire building or adjacent buildings or in a parking area.

### BACKGROUND

### 1. Field

Aspects of the present invention generally relate to a fire safe electric vehicle (EV) charging system.

### 2. Description of the Related Art

Fires affecting a Li-Ion battery of Hybrid and Electric Vehicles (H/EVs) are hard to contain and can cause extensive damage in their vicinity. These fires normally happen either during an accident or while charging the battery. There is currently no mechanism to avoid or restrict such fires in their early stages, when they originate from a battery failure while it is being charged.

At this point there are fire alarm systems, but without any automation related to EV charging, so any action related to EV charging is done manually, if at all, in case of an emergency.

Therefore, a system is then needed for detecting a fire and shutting off charging to the electric vehicle(s).

### SUMMARY

Briefly described, aspects of the present invention relate to a fire safe electric vehicle (EV) charging system. This invention presents a mechanism to detect a fire and shut off charging to the vehicle(s) in the vicinity/zone, reducing the potential fire impact and allowing vehicles that lock themselves to the charger to be moved. The invention relies on a fire alarm system protecting a certain zone. The fire alarm system includes different control groups, with a set of causes and effects. Effects include turning off main lights and turning on emergency lights, sounding audible alarms, unlocking doors, etc. One novelty is to connect an EV charger to a control group, either through a Dry Contact (outputs from the fire alarm system, inputs into the EV charger), or through a Modbus TCP or Modbus RTU direct connection, or through an EV charger software management system. Regardless of the Connection mechanism, the fire alarm system shuts down the EV chargers when fire is present. It can shut down all EV chargers either in the same zone as where the fire is detected, or in the entire building or adjacent buildings or in the parking area.

In accordance with one illustrative embodiment of the present invention, an electric vehicle (EV) charging management system is provided. It is configured for managing charging of a hybrid/electric vehicle (H/EV). The EV charging management system comprises an EV charging system for charging a Lithium-Ion (Li-Ion) battery and an automatic mechanism of the EV charging system which is related to charging of the H/EV to avoid or restrict fires affecting the Li-Ion battery in their early stages, when they originate from a battery failure while it is being charged. The automatic mechanism comprises a heat/smoke/gas/particle sensor, a turn-off switch, a processor and a memory storing software (SW) instructions that, when executed by the processor, cause the automatic mechanism to: detect a fire by sensing heat/smoke/particles via the heat/smoke/gas/particle sensor, and shut off charging to H/EV(s) via the turn-off switch in a vicinity/zone, reducing the potential fire impact and allowing the H/EV(s) that lock themselves to an electric vehicle supply equipment (EVSE) to be moved.

In accordance with one illustrative embodiment of the present invention, a method is provided. The method provides an electric vehicle (EV) charging management system configured for managing charging of a hybrid/electric vehicle (H/EV). The method comprises providing an EV charging system for charging a Lithium-Ion (Li-Ion) battery and providing an automatic mechanism of the EV charging system which is related to charging of the H/EV to avoid or restrict fires affecting the Li-Ion battery in their early stages, when they originate from a battery failure while it is being charged. The automatic mechanism comprises a heat/smoke/gas/particle sensor, a turn-off switch, a processor and a memory storing software (SW) instructions that, when executed by the processor, cause the automatic mechanism to: detect a fire by sensing heat/smoke/particles via the heat/smoke/gas/particle sensor, and shut off charging to H/EV(s) via the turn-off switch in a vicinity/zone, reducing the potential fire impact and allowing the H/EV(s) that lock themselves to an electric vehicle supply equipment (EVSE) to be moved.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a fire safe electric vehicle (EV) charging system connected to an EV in accordance with an embodiment of the present invention.

FIG. 2 illustrates a detailed fire safe electric vehicle (EV) charging system for an EV for shutting down EV charging upon detection of a fire inside the EV in accordance with an embodiment of the present invention.

FIG. 3 illustrates a fire safe electric vehicle (EV) charging system that includes different control groups, with a set of causes and effects in accordance with an embodiment of the present invention.

FIG. 4 illustrates a fire safe electric vehicle (EV) charging system protecting a certain zone in accordance with an embodiment of the present invention.

FIG. 5 illustrates a method of providing a hybrid/electric vehicle (H/EV) configured for fire safe H/EV charging in accordance with an embodiment of the present invention.

### DETAILED DESCRIPTION

Various technologies that pertain to systems and methods that provide a fire safe electric vehicle (EV) charging system are presented. Shutting down EV charging in a controlled manner has the advantage of possibly releasing the cables from the vehicles being charged, and possibly stopping to charge the affected EV, especially when the fire alarm system has an early detection mechanism that can detect smoke before the fire has stopped the charging process, possibly preventing a large fire. It also allows using the displays on the chargers (if present) for indication to notify people to leave the area, if the displays are programmed to do so when a shutdown due to fire is present. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present invention, they are explained hereinafter with reference to implementation in illustrative embodiments. In particular, they are described in the context of a fire safe electric vehicle (EV) charging system. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

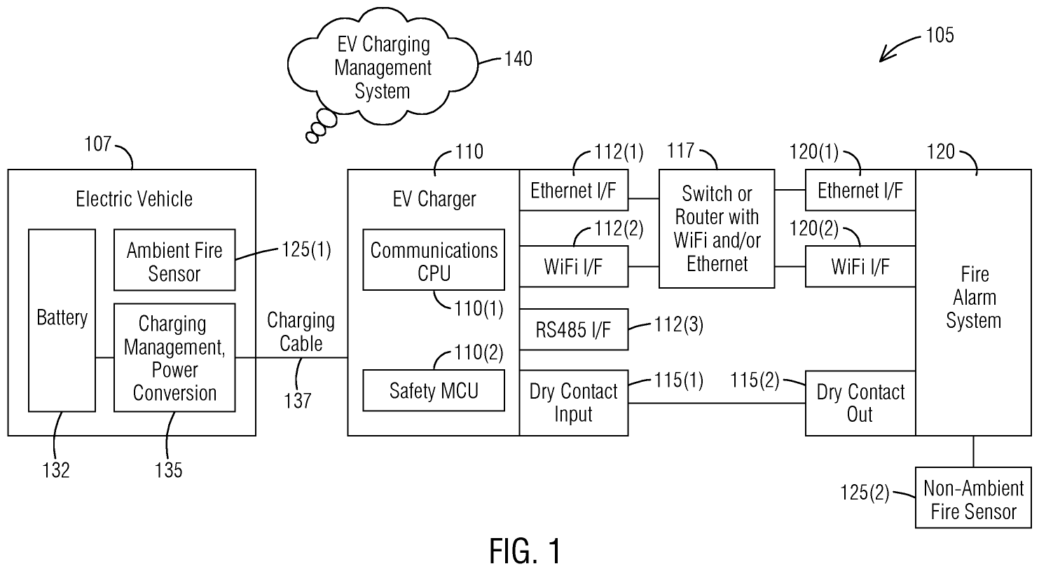

These and other embodiments of the system are provided for providing a fire safe electric vehicle (EV) charging system according to the present disclosure are described below with reference to FIG. 1 herein. The drawing is not necessarily drawn to scale.

Consistent with an embodiment of the present invention, FIG. 1 represents a fire safe electric vehicle (EV) charging system 105 connected to an electric vehicle (EV) 107 in accordance with an embodiment of the present invention. The system 105 comprises an EV charger 110 which includes communications and central processing unit (CPU) 110(1) and a safety micro controller unit (MCU) 110(2). The EV charger 110 further includes a first Ethernet interface (I/F) 112(1), a first. Wi-Fi interface (I/F) 112(2), a RS485 I/F 112(3) and a dry contact input 115(1). The system 105 further comprises a switch 117 or router with Wi-Fi and/or Ethernet.

The system 105 further comprises a fire alarm system 120 that includes a second Ethernet interface (I/F) 120(1), a second Wi-Fi interface (I/F) 120(2) coupled to the switch 117. The fire alarm system 120 further includes a dry contact out 115(2) connected to the dry contact input 115(1). The system 105 further comprises an ambient fire sensor 125(1) coupled to the fire alarm system 120. The fire alarm system 120 may be located in a computer in a building.

An EV 107 having an EV battery 132 coupled to a charging management, power conversion unit 135 which is further coupled to the EV charger 110 via a charging cable 137. The EV charger 110 is configured to charge the EV 107. The fire alarm system 120 along with the ambient fire sensor 125(1) provide fire detection and alarm capability when the EV 107 is being charged.

The ambient fire sensor 125(1) may be provided inside the EV 107 plus a non-ambient fire sensor 125(2) may be provided external to the EV 107 such that it may be situated in a garage at a relatively higher location to the EV battery 132 to detect rising smoke/fire from the EV battery 132 fire started at the time of EV charging.

The system 105 further comprises an EV charging management system 140 in a cloud. The EV charging management system 140 may be an end-to-end software solution for managing EV charging operations, EV charging billing, energy management, EV driver management, and EV Fleet management. The best way to extend EV battery life is by depleting it to 20% and then charging it up to 80%. This is because of the way the battery works. The more charge cycles it goes through, the quicker its capacity drops. So sticking between 20-80% ensures the battery is never fully depleted or fully charged. There are two wired methods, AC and DC, where in AC charging the AC/DC conversion is performed inside the EV, whereas in DC charging the AC/DC conversion is performed inside the EVSE. In addition to this there is also a wireless charging method, in which there is no cable connecting between EV and EVSE, it is inductive charging. The EV charging management system 140 may support cascading multiple EV chargers onto a single electric wire. The available current can be managed dynamically between units so that connected cars can be charged simultaneously.

A battery charger (or a battery charge controller) is provided inside the EV 107. Inside the EV 107, on top of the EV battery 132 such as the Li-Ion battery, there is a battery charger.

An electric vehicle (EV) charging management system comprises an EV charging system for charging a Li-Ion battery and an automatic mechanism related to charging of a hybrid/electric vehicle (H/EV) to avoid or restrict fires affecting the Li-Ion battery. The automatic mechanism comprises a heat/smoke/gas/particle sensor, a turn-off switch, a processor and a memory storing software (SW) instructions that, when executed by the processor, cause the automatic mechanism to detect a fire and shut off charging to H/EV(s). The automatic mechanism further comprises a fire alarm system for protecting a certain zone. The fire alarm system includes different control groups, with a set of causes and effects. The EV charging management system to connect an EV charger to a control group. The EV charging management system can shut down all EV chargers either in a same zone as where the fire is detected, or in an entire building or adjacent buildings or a parking area.

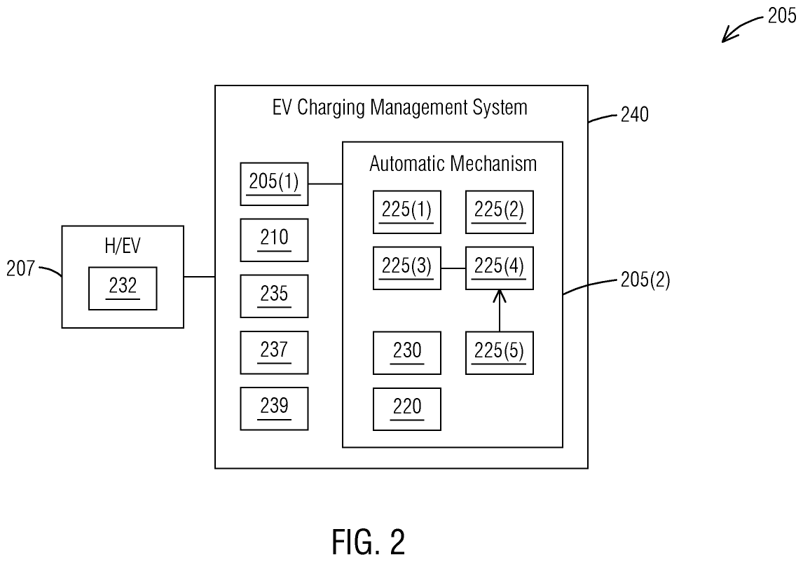

Referring to FIG. 2, it illustrates a detailed fire safe electric vehicle (EV) charging system 205 for a hybrid/electric vehicle (H/EV) 207 for shutting down EV charging upon detection of a fire inside the hybrid/electric vehicle (H/EV) 207 in accordance with an embodiment of the present invention. The system 205 comprises an EV charging management system 240 configured for managing charging of the hybrid/electric vehicle (H/EV) 207. The EV charging management system 240 comprises an EV charging system 205(1) for charging a Lithium-Ion (Li-Ion) battery 232.

The EV charging management system 240 further comprises an automatic mechanism 205(2) of the EV charging system 205(1) which is related to charging of the H/EV 207 to avoid or restrict fires affecting the Li-Ion battery 232 in their early stages, when they originate from a battery failure while it is being charged. The automatic mechanism 205(2) comprises a heat/smoke/gas/particle sensor 225(1), a turn-off switch 225(2), a processor 225(3) and a memory 225(4) storing software (SW) instructions 225(5) that, when executed by the processor 225(3), cause the automatic mechanism 205(2) to: detect a fire by sensing a heat/smoke/particles threshold 230 via the heat/smoke/gas/particle sensor 225(1) and shut off charging to H/EV(s) via the turn-off switch 225(2) in a vicinity/zone, reducing the potential fire impact and allowing the H/EV(s) that lock themselves to an electric vehicle supply equipment (EVSE) to be moved.

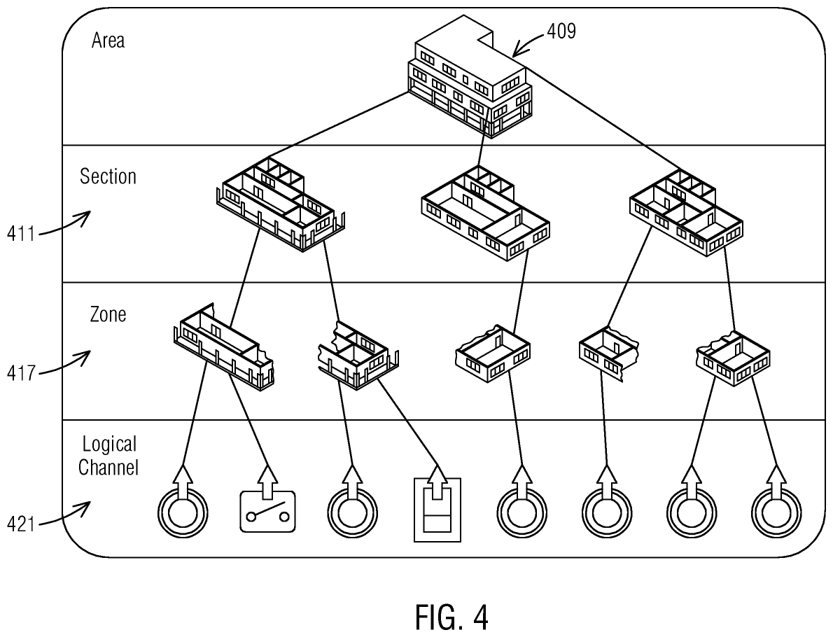

The automatic mechanism further comprises a fire alarm system 220 protecting a certain zone (see FIG. 4). The fire alarm system 220 includes different control groups (see FIG. 4), with a set of causes and effects (see FIG. 4). The effects include turning off main lights and turning on emergency lights, sounding audible alarms, and/or unlocking doors.

The EV charging management system 240 to connect an EV charger 210 such as the electric vehicle supply equipment (EVSE) to a control group either through a Dry Contact (outputs from the fire alarm system 220, inputs into the EV charger) or BACnet communication. The EVSE (a.k.a. EV charger) is a box external to the (H/EV) 207, to which the (H/EV) 207 plugs in through a charging cable. The EV charging management system 240 to connect the EV charger 210 such as the electric vehicle supply equipment (EVSE) to a control group through a Modbus TCP or Modbus RTU direct connection. The EV charging management system 240 to connect the EV charger 210 such as the electric vehicle supply equipment (EVSE) to a control group through an EV charger software management system 235. An additional protocol that can be used is Open Charge Point Protocol (OCPP) or may be a proprietary protocol. The Open Charge Point Protocol is an application protocol for communication between Electric vehicle charging stations and a central management system, also known as a charging station network.

Regardless of a connection mechanism, the fire alarm system 220 shuts down EV chargers when fire is present. The EV charging management system 240 can shut down all EV chargers either in a same zone as where the fire is detected, or in an entire building or adjacent buildings or a parking area. The electric vehicle supply equipment (EVSE) including a dry contact input to receive inputs. Normally the inputs at the dry contact input in the EVSE are programmed to allow an external electrical circuit 237 to shut down the EVSE. A logic 239 behind the external electrical circuit 237 is to turn off delivery of power to the H/EV 207.

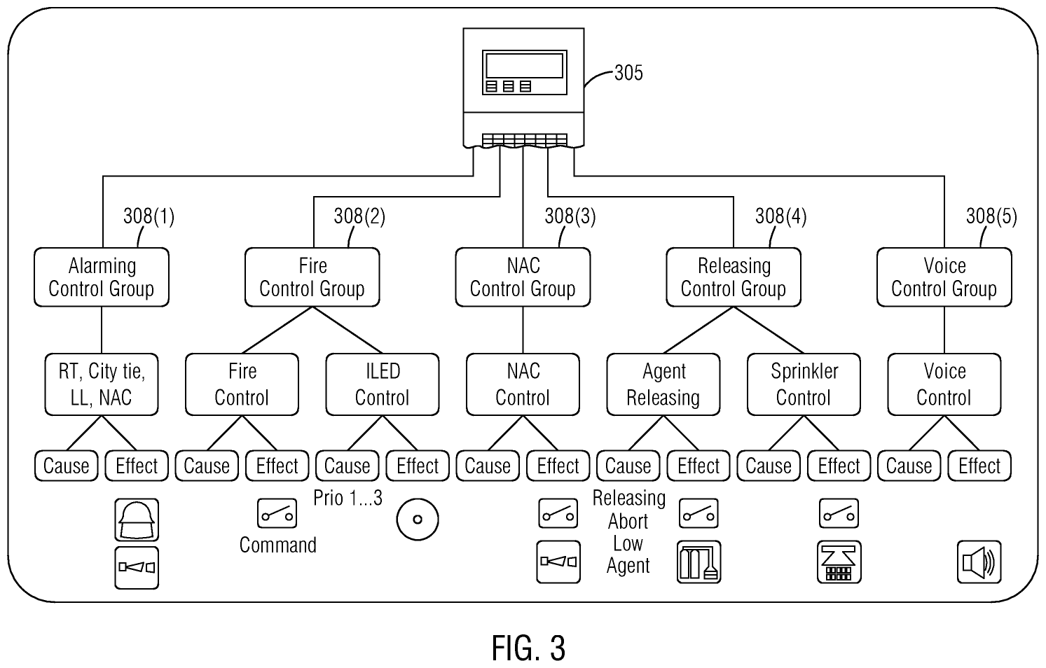

Turning now to FIG. 3, it illustrates a fire safe electric vehicle (EV) charging system 305 that includes different control groups, with a set of causes and effects in accordance with an embodiment of the present invention. Different control groups include an alarming control group 308(1), a fire control group 308(2), a Network access control (NAC) control group 308(3), a releasing control group 308(4), and a voice control group 308(5). Elements of the alarming control group 308(1) are controls for internal and external alarm devices and remote transmission outputs for ‘Fire’ and ‘Fault.’ The Fire Control Group or FGC 308(2) is the name of the group of parts that fire a device. It is the group of parts consisting of the trigger, hammer, disconnector, and sear. Network access control (NAC) of the NAC control group 308(3) is a security solution that enforces policy on devices that access networks to increase network visibility and reduce risk. Releasing Control Group 308(4) covers agent or sprinkler releasing functions. Voice Control Group 308(5) covers complex control functions for voice evacuation.

FIG. 4 illustrates a fire safe electric vehicle (EV) charging system 405 protecting a certain zone in accordance with an embodiment of the present invention. The system 405 comprises an area 409, a section 411, a zone 417, and a logical channel 421.

The Area 409 usually controls the alarm organization (MANNED/UNMANNED), but it might also be configured to stay in manned or unmanned mode. The Section 411 is used to operate a collection of Zones together in a safe and easy way. It allows switching the mode to: ON, OFF etc. The Zone 417 is a required element which handles the raw alarm information coming from one or multiple connected detectors. Some of them apply a pre-stage (usually pre-alarm) prior to the main-stage (usually fire alarm). Further, it supports several operating modes influencing the sensitivity of attached detectors. Different kinds of Zones have to be used according to the desired purpose. The Logical Channel 421 is a required element providing the raw information of detection devices (Sensor Channels) or technical alarms coming from other systems (Input Channels). These are exclusively used for detection. Logical Channels have to be configured and become linked to Physical Channels.

This invention presents a mechanism to detect a fire and shut off charging to the vehicle(s) in the vicinity/zone, reducing the potential fire impact and allowing vehicles that lock themselves to the charger to be moved. The invention relies on a fire alarm system protecting a certain zone (See FIG. 4). The fire alarm system includes different control groups, with a set of causes and effects. Effects include turning off main lights and turning on emergency lights, sounding audible alarms, unlocking doors, etc. One novelty is to connect an EV charger to a control group, either through a Dry Contact (outputs from the fire alarm system, inputs into the EV charger), or through a Modbus TCP or Modbus RTU direct connection, or through an EV charger software management system. Regardless of the Connection mechanism, the fire alarm system shuts down the EV chargers when fire is present. It can shut down all chargers either in the same zone as where the fire is detected, or in the entire building or adjacent buildings or in the parking area. Shutting down EV charging in a controlled manner has the advantage of possibly releasing the cables from the vehicles being charged, and possibly stopping to charge the affected EV, especially when the fire alarm system has an early detection mechanism that can detect smoke before the fire has stopped the charging process, possibly preventing a large fire. It also allows using the displays on the chargers (if present) for indication to notify people to leave the area, if the displays are programmed to do so when a shutdown due to fire is present.

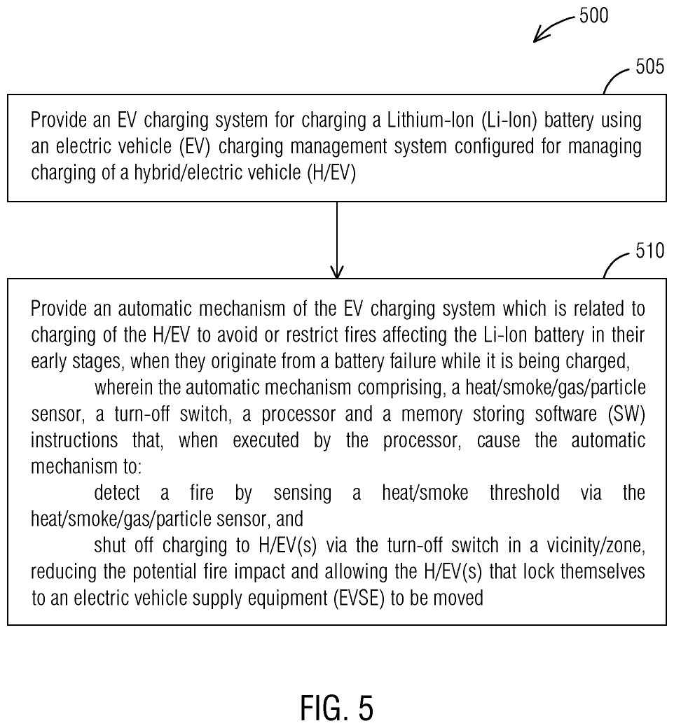

As seen in FIG. 5, it illustrates a method 500 for providing a hybrid/electric vehicle (H/EV) configured for fire safe H/EV charging in accordance with an exemplary embodiment of the present invention. Reference is made to the elements and features described in FIGS. 1-4. It should be appreciated that some steps are not required to be performed in any particular order, and that some steps are optional.

The method 500 comprises a step 505 of providing an EV charging system for charging a Lithium-Ion (Li-Ion) battery using an electric vehicle (EV) charging management system configured for managing charging of a hybrid/electric vehicle (H/EV). The method 500 further comprises a step 510 of providing an automatic mechanism of the EV charging system which is related to charging of the H/EV to avoid or restrict fires affecting the Li-Ion battery in their early stages, when they originate from a battery failure while it is being charged. The automatic mechanism comprises a heat/smoke/gas/particle sensor, a turn-off switch, a processor and a memory storing software (SW) instructions that, when executed by the processor, cause the automatic mechanism to: detect a fire by sensing heat/smoke/particles (particle size signatures) via the heat/smoke/gas/particle sensor, and shut off charging to H/EV(s) via the turn-off switch in a vicinity/zone, reducing the potential fire impact and allowing the H/EV(s) that lock themselves to an electric vehicle supply equipment (EVSE) to be moved.

While a fire safe electric vehicle (EV) charging system is described here a range of one or more other charging systems are also contemplated by the present invention. For example, other systems may be implemented based on one or more features presented above without deviating from the spirit of the present invention.

The techniques described herein can be particularly useful for any connection between a fire alarm system and shutting down EV charging. While particular embodiments are described in terms of this connection, the techniques described herein are not limited to such a system but can also be used with other types of systems.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment.” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. An electric vehicle (EV) charging management system configured for managing charging of a hybrid/electric vehicle (H/EV), the EV charging management system comprising:
an EV charging system for charging a Lithium-Ion (Li-Ion) battery; and
an automatic mechanism of the EV charging system which is related to charging of the H/EV to avoid or restrict fires affecting the Li-Ion battery in their early stages, when they originate from a battery failure while it is being charged,
wherein the automatic mechanism comprising, a heat/smoke/gas/particle sensor, a turn-off switch, a processor and a memory storing software (SW) instructions that, when executed by the processor, cause the automatic mechanism to:
detect a fire by sensing heat/smoke/particles via the heat/smoke/gas/particle sensor, and
shut off charging to H/EV(s) via the turn-off switch in a vicinity/zone, reducing the potential fire impact and allowing the H/EV(s) that lock themselves to an electric vehicle supply equipment (EVSE) to be moved.

2. The EV charging management system of claim 1, wherein the automatic mechanism further comprising:
a fire alarm system protecting a certain zone, wherein the fire alarm system includes different control groups, with a set of causes and effects.

3. The EV charging management system of claim 2, wherein the effects include turning off main lights and turning on emergency lights, sounding audible alarms, and/or unlocking doors.

4. The EV charging management system of claim 2, wherein the EV charging management system to connect an EV charger such as the electric vehicle supply equipment (EVSE) to a control group either through a Dry Contact (outputs from the fire alarm system, inputs into the EV charger) or BACnet communication.

5. The EV charging management system of claim 2, wherein the EV charging management system to connect an EV charger such as the electric vehicle supply equipment (EVSE) to a control group through a Modbus TCP or Modbus RTU direct connection.

6. The EV charging management system of claim 2, wherein the EV charging management system to connect an EV charger such as the electric vehicle supply equipment (EVSE) to a control group through an EV charger software management system.

7. The EV charging management system of claim 2, wherein regardless of a connection mechanism, the fire alarm system shuts down EV chargers when fire is present.

8. The EV charging management system of claim 7. wherein the EV charging management system can shut down all EV chargers either in a same zone as where the fire is detected, or in an entire building or adjacent buildings or in a parking area.

9. The EV charging management system of claim 1, wherein the electric vehicle supply equipment (EVSE) including a dry contact input to receive inputs, and
wherein normally the inputs at the dry contact input in the EVSE are programmed to allow an external electrical circuit to shut down the EVSE.

10. The EV charging management system of claim 9, wherein a logic behind the external electrical circuit is to turn off delivery of power to the H/EV.

11. A method of providing an electric vehicle (EV) charging management system configured for managing charging of a hybrid/electric vehicle (H/EV), the method comprising:
providing an EV charging system for charging a Lithium-Ion (Li-Ion) battery; and
providing an automatic mechanism of the EV charging system which is related to charging of the H/EV to avoid or restrict fires affecting the Li-Ion battery in their early stages, when they originate from a battery failure while it is being charged,
wherein the automatic mechanism comprising, a heat/smoke/gas/particle sensor, a turn-off switch, a processor and a memory storing software (SW) instructions that, when executed by the processor, cause the automatic mechanism to:
detect a fire by sensing heat/smoke/particles via the heat/smoke/gas/particle sensor, and
shut off charging to H/EV(s) via the turn-off switch in a vicinity/zone, reducing the potential fire impact and allowing the H/EV(s) that lock themselves to an electric vehicle supply equipment (EVSE) to be moved.

12. The method of claim 11, wherein the automatic mechanism further comprising:
a fire alarm system protecting a certain zone, wherein the fire alarm system includes different control groups, with a set of causes and effects.

13. The method of claim 12, wherein the effects include turning off main lights and turning on emergency lights, sounding audible alarms, and/or unlocking doors.

14. The method of claim 12, wherein the EV charging management system to connect an EV charger such as the electric vehicle supply equipment (EVSE) to a control group either through a Dry Contact (outputs from the fire alarm system, inputs into the EV charger) or BACnet communication.

15. The method of claim 12, wherein the EV charging management system to connect an EV charger such as the electric vehicle supply equipment (EVSE) to a control group through a Modbus TCP or Modbus RTU direct connection.

16. The method of claim 12, wherein the EV charging management system to connect an EV charger such as the electric vehicle supply equipment (EVSE) to a control group through an EV charger software management system.

17. The method of claim 12. wherein regardless of a connection mechanism, the fire alarm system shuts down EV chargers when fire is present.

18. The method of claim 17, wherein the EV charging management system can shut down all EV chargers either in a same zone as where the fire is detected, or in an entire building or adjacent buildings or in a parking area.

19. The method of claim 11, wherein the electric vehicle supply equipment (EVSE) including a dry contact input to receive inputs, and
wherein normally the inputs at the dry contact input in the EVSE are programmed to allow an external electrical circuit to shut down the EVSE.

20. The method of claim 19, wherein a logic behind the external electrical circuit is to turn off delivery of power to the H/EV.
